(19) United States
(12) Patent Application Publication
(10) Pub. No.: US 2018/0076675 A1
(43) Pub. Date: Mar. 15, 2018

(54) ARMATURE CORE, ARMATURE, AND LINEAR MOTOR

(71) Applicant: Mitsubishi Electric Corporation, Chiyoda-ku (JP)

(72) Inventors: Hiroshi WAKAYAMA, Tokyo (JP); Eigo TOTOKI, Tokyo (JP); Shinichi YAMAGUCHI, Tokyo (JP); Kenta MOTOYOSHI, Tokyo (JP); Yosuke TAKAISHI, Tokyo (JP)

(73) Assignee: Mitsubishi Electric Corporation, Chiyoda-ku (JP)

(21) Appl. No.: 15/557,301

(22) PCT Filed: May 26, 2015
(86) PCT No.: PCT/JP2015/065119

§ 371 Date: Sep. 11, 2017

(51) Int. Cl. H02K 1/24; H02K 3/18; H02K 41/03

(52) U.S. Cl. CPC H02K 1/24; H02K 41/031; H02K 3/18

(57) ABSTRACT

Two teeth on which windings are wound, and a teeth connecting portion disposed between the two teeth, connecting the teeth together, and having a mounting hole formed therein, are arranged in a line in a second direction, which is an arrangement direction. The teeth connecting portion has a support that supports the windings. The support has projections protruding from both end portions in the second direction of the teeth connecting portion to both sides in a first direction which is a width direction, and spaces formed between the projections in the second direction.

### FIELD

The present invention relates to an armature core, an armature, and a linear motor.

### BACKGROUND

Linear motors are known as apparatuses for transferring a carrier. A linear motor produces thrust between a field element as a stator, and an armature as a moving element, to move the armature in one direction. In recent years, demand for increased travel speed of the carrier has been rising. To increase the travel speed of the carrier, an armature needs to be increased in acceleration. To increase the acceleration of the armature, it is required to increase the thrust of a linear motor, or to reduce the weight of the moving element side, that is, to reduce the weight of the armature.

To increase the thrust of linear motors, a technique of effectively linking magnetic flux with armature cores has been proposed. Patent Literature 1 describes a configuration in which butted protruding portions are provided on both sides of an armature core in the travel direction, and cooling grooves are provided in butted faces to be able to efficiently cool the armature core, so that a number of turns of a winding wound on the armature core can be provided. Patent Literature 2 describes a configuration in which butted protruding portions are provided on both sides of an armature core in the travel direction, and a bolt mounting hole is provided in each butted protruding portion to facilitate the passage of magnetic flux through a central portion of the armature core. Patent Literature 3 describes a configuration in which a gap is left between adjacent armature cores to reduce leakage flux.

### CITATION LIST

### Patent Literature

Patent Literature 1: WO 2013/145085 A

Patent Literature 2: JP 2011-4555 A

Patent Literature 3: JP 2003-143829 A

### SUMMARY

### Technical Problem

In the configuration of Patent Literature 1, the mass is increased by the provision of the butted protruding portions on both sides of each armature core, and can reduce the acceleration of the armature. In the configuration of Patent Literature 2, mounting holes are provided in two portions, so that a loop is formed between bolts fitted to an armature core, the armature core, and a mounting member. Magnetic flux through the armature core passes through this loop, alternating, and linking. Thus, eddy currents canceling magnetic flux in the armature core flow through the loop, causing circulating current losses, and thus can reduce the thrust and reduce the acceleration of the armature. In Patent Literature 2, the mass is increased by the provision the butted protruding portions on both sides of each armature core, and can reduce the acceleration of the armature.

In the configuration of the Patent Literature 3, when a gap between adjacent armature cores is increased, windings wound on the armature cores cannot be supported in some cases. In these cases, a winding cannot be wound in the entire space, so that it becomes difficult to increase the thrust, and it becomes difficult to increase the acceleration of the armature.

The present invention has been made in view of the above, and has an object of providing an armature core capable of increasing the speed of travel of an armature, an armature having the armature core, and a linear motor having the armature.

### Solution to Problem

In order to solve the above-described problem and attain the object, the present invention includes two teeth on which windings are wound, and a teeth connecting portion disposed between the two teeth, connecting the teeth together, and having a mounting hole formed therein, the two teeth and the teeth connecting portion being arranged in a line, the teeth connecting portion having a support that supports the windings, the support having projections protruding from both end portions of the teeth connecting portion in an arrangement direction which is a direction in which the two teeth and the teeth connecting portion are aligned, to both sides in a width direction which is a direction orthogonal to the arrangement direction, and spaces formed between the projections in the arrangement direction.

### Advantageous Effects of Invention

According to the present invention, the spaces are provided in portions of the armature core unnecessary in a magnetic circuit, so that the armature core can be reduced in weight without affecting magnetic flux flowing through the armature core. Further, by providing the projections at the support, the windings can be supported, and the windings can be wound more than ever before, so that the thrust can be increased. Thus, the reduced weight and the increased thrust of the armature core can increase the acceleration of the armature.

### BRIEF DESCRIPTION OF DRAWINGS

FIG. 1 is a plane cross-sectional view illustrating a linear motor according to a first embodiment.

FIG. 2 is a plan view illustrating an armature core according to the first embodiment.

FIG. 3 is a cross-sectional view illustrating a state in which windings are held on the armature core according to the first embodiment.

FIG. 4 is a view for explaining the dimension of projections in a second direction according to the first embodiment.

FIG. 5 is a view showing dimensions of parts of the armature core according to the first embodiment.

FIG. 6 is a view illustrating an example of lines of magnetic flux formed through the armature cores according to the first embodiment.

FIG. 7 is a plane cross-sectional view illustrating a linear motor according to a second embodiment.

FIG. 8 is a view showing the configuration and dimensions of parts of an armature core according to the second embodiment.

FIG. 9 is a plan view illustrating another armature core according to the second embodiment.

FIG. 10 is a plan view illustrating another armature core according to the second embodiment.

FIG. 11 is a plan view illustrating an armature core according to a third embodiment.

FIG. 12 is a perspective view illustrating an armature core according to a fourth embodiment.

FIG. 13 is a plan view showing the armature core according to the fourth embodiment.

FIG. 14 is a plane cross-sectional view illustrating an armature core according to a fifth embodiment.

FIG. 15 is a plane cross-sectional view illustrating another armature core according to the fifth embodiment.

FIG. 16 is a plane cross-sectional view illustrating another armature core according to the fifth embodiment.

### DESCRIPTION OF EMBODIMENTS

Hereinafter, armature cores, armatures, and linear motors according to embodiments of the present invention will be described in detail with reference to the drawings. The embodiments are not intended to limit the invention.

### First Embodiment

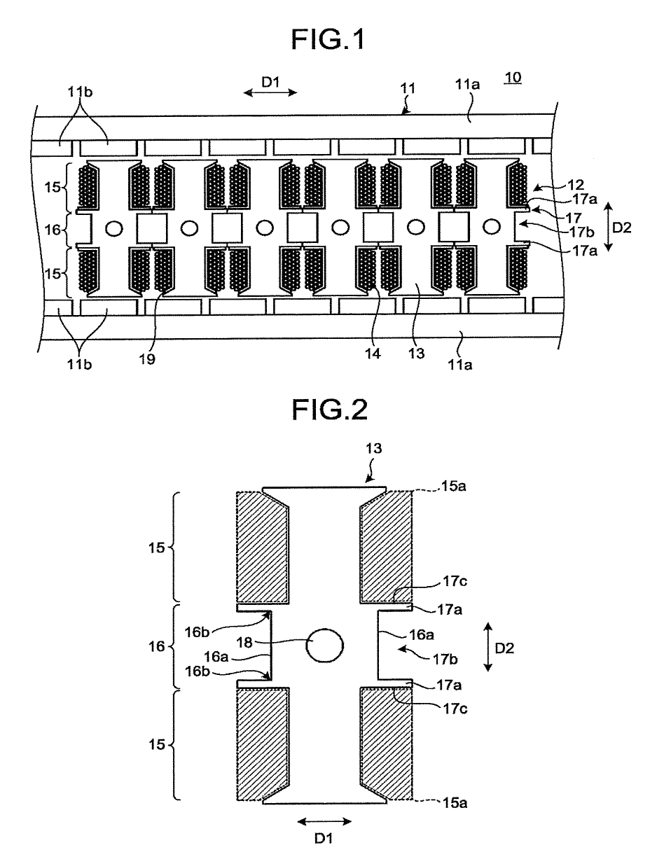

FIG. 1 is a plane cross-sectional view illustrating a linear motor 10 according to a first embodiment. The linear motor 10 includes a field element 11 as a stator, and an armature 12 as a moving element. The linear motor 10 moves the armature 12 in a first direction D1 by thrust generated between the field element 11 and the armature 12. The linear motor 10 is a bilateral-system linear motor in which thrust generation planes are formed on both sides in a second direction D2 of the armature 12. The armature 12 is provided with a holder that holds a carrier. The linear motor 10 moves the armature 12 with the holder holding a carrier, thereby transferring the carrier.

The field element 11 has two field yokes 11a and a plurality of permanent magnets 11b. The two field yokes 11a are disposed with spacing in the second direction D2. The two field yokes 11a are formed in a shape extending in the first direction D1. The two field yokes 11a are disposed in parallel.

The plurality of permanent magnets 11b is provided on the field yokes 11a. The plurality of permanent magnets 11b is disposed with a regular pitch in a row along the first direction D1 on each field yoke 11a. Thus, the plurality of permanent magnets 11b is provided in two rows with spacing in the second direction D2. The polarity of the permanent magnets 11b differs alternately in the first direction D1.

The armature 12 is disposed between the permanent magnets 11b arranged in two rows. The armature 12 has a plurality of armature cores 13 arranged in a line in the first direction D1, and windings 14 held on the armature cores 13. The armature cores 13 are formed by stacking a plurality of plate-shaped core members. Each armature core 13 is fixed to a mounting plate by a bolt not illustrated.

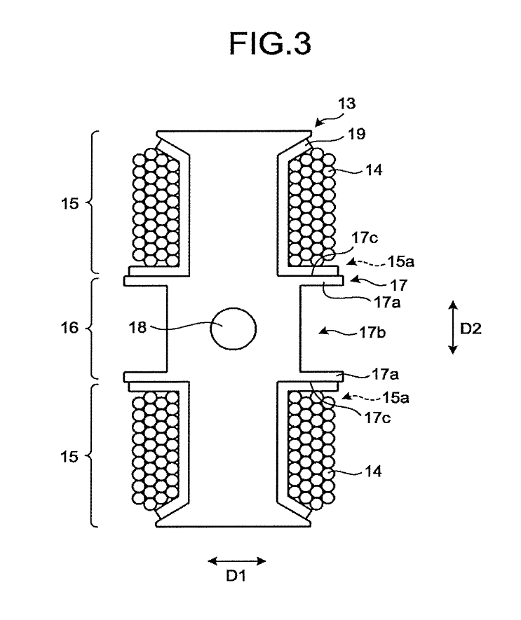

FIG. 2 is a plan view illustrating the armature core 13 according to the first embodiment. FIG. 2 omits the illustration of the windings 14 and bobbins 19, and illustrates only slots 15a. FIG. 3 is a cross-sectional view illustrating a state in which the windings 14 are held on the armature core 13 according to the first embodiment. As illustrated in FIGS. 2 and 3, the armature core 13 has two teeth 15 on which the windings 14 are disposed, and a teeth connecting portion 16 that connects the two teeth 15 together. The two teeth 15 and the teeth connecting portion 16 are arranged in a line in the second direction D2. Thus, the second direction D2 is an arrangement. direction in which the two teeth 15 and the teeth connecting portion 16 are aligned. The first direction D1 is a width direction orthogonal to the arrangement direction.

The teeth 15 are disposed at both ends in the second direction D2 of the armature core 13. The slots 15a are formed in the teeth 15. The bobbins 19 are fitted in the slots 15a. The windings 14 are wound on the teeth 15 via the bobbins 19 shown in FIG. 3.

The teeth connecting portion 16 is disposed between the two teeth 15 in the second direction D2. The teeth connecting portion 16 has a mounting hole 18. The mounting hole 18 is formed therethrough in the stacking direction of the core members. The mounting hole 18 is formed in a circular shape as viewed in the stacking direction of the core members. A bolt for mounting the armature core 13 to the mounting plate is inserted into the mounting hole 18. The mounting hole 18 is disposed at the center of the teeth connecting portion 16 in the second direction D2 and the first direction D1. End faces 16a of the teeth connecting portion 16 on both sides in the first direction D1 are formed in a flat shape.

A support 17 is provided at the teeth connecting portion 16. The support 17 protrudes from the teeth connecting portion 16 to both sides in the first direction D1. The support 17 has projections 17a and spaces 17b. The projections 17a protrude in the first direction D1 as the width direction, from end portions 16b of the teeth connecting portion 16 on both sides in the second direction D2. The projections 17a are formed in a plate shape. The thickness of the projections 17a, that is, the dimension in the second direction D2 is about one time to three times the thickness of the core member. The projections 17a can support the windings 14 on faces 17c on the teeth 15 sides.

The spaces 17b are formed in portions each surrounded by the two projections 17a aligned in the second direction D2 and the end face 16a of the teeth connecting portion 16. The spaces 17b are provided in isolation from the mounting hole 18. By the formation of the spaces 17b in the support 17, the armature core 13 is reduced in weight.

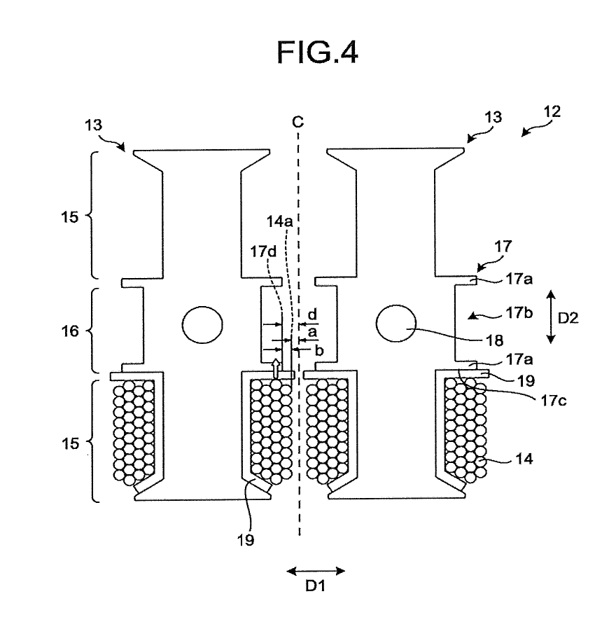

FIG. 4 is a view for explaining the dimension of the projections 17a in the first direction D1. FIG. 4 omits the illustration of some of the windings 14 and the bobbins 19. In FIG. 4, a center plane between the adjacent armature cores 13 is a plane C. A distance a is a distance from an outermost portion 14a of the surface of the winding 14 in the first direction D1 to the plane C. The distance a is smaller than or equal to one time the diameter of the winding 14. A distance b is a distance from a portion 17d of the projection 17a subject to the load of the winding 14 to the outermost portion 14a of the surface of the winding 14 in the first direction D1. The distance b is larger than the diameter of the winding 14, and is one-and-a-half times the diameter in the first embodiment. The distance b is not limited to one-and-a-half times the diameter of the winding 14.

A distance d is a distance from a distal end of the projection 17a to the plane C, and is the total value of the distance a and the distance b. Thus, the distance d can be set to a dimension smaller than or equal to two-and-a-half times the diameter of the winding 14. This can prevent the distal end of the projection 17a in the first direction D1 from being too far apart from the distal end of the bobbin 19 in the first direction D1. Consequently, the projections 17a can support the winding 14. When the distance d is zero, that is, when the adjacent armature cores 13 contact each other at the distal ends of the projections 17a, the strength of the projections 17a can be increased, compared to the case where the distal ends of the projections 17a are apart from each other.

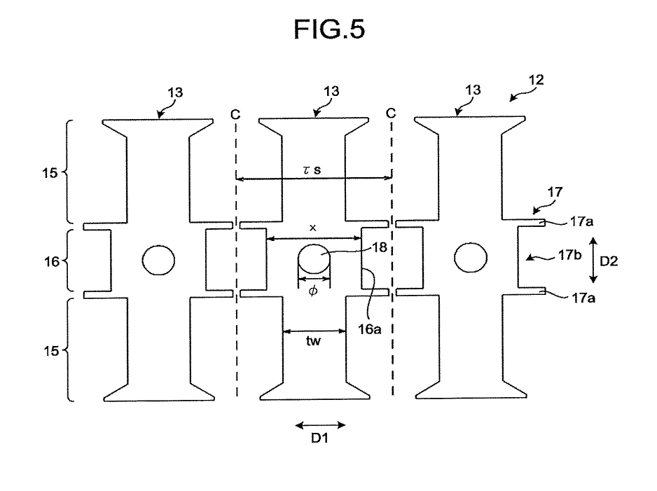

FIG. 5 is a view illustrating dimensions of parts of the armature core 13 according to the first embodiment. As illustrated in FIG. 5, the dimension in the first direction D1 of the teeth 15 is tw, the dimension in the first direction D1 of the teeth connecting portion 16 is x, the diameter of the mounting hole 18 is φ, and the pitch of the armature core 13 in the first direction D1 is τs. Then, the parts of the armature core 13 satisfy τs−φ>x−φ≧tw. The dimension tw is equal to a magnetic circuit width of the teeth 15. A magnetic circuit is formed around the mounting hole 18 in the teeth connecting portion 16, so that no magnetic circuit is formed in the mounting hole 18. Thus, x−φ, the difference between the dimension x and the diameter φ, is equal to a magnetic circuit width of the teeth connecting portion 16. Here, when the magnetic circuit width x−φ of the teeth connecting portion 16 is smaller than the magnetic circuit width tw of the teeth 15, magnetic saturation occurs in the teeth connecting portion 16 when magnetic flux flows from the teeth 15 to the teeth connecting portion 16. By contrast, the parts of the armature core 13 satisfy the above expression x−φ≧tw. Thus, the magnetic circuit width x−φ of the teeth connecting portion 16 is equal to the magnetic circuit width tw of the teeth 15 or larger than the magnetic circuit width tw of the teeth 15. This avoids magnetic saturation in the teeth connecting portion 16, and thus can prevent a reduction in thrust. The parts of the armature core 13 satisfy the above expression τs−φ>x−φ. That is, the dimension x in the first direction D1 of the teeth connecting portion 16 is a dimension not exceeding the pitch τs of the armature core 13 in the first direction D1. Thus, the magnetic circuit width x−φ of the teeth connecting portion 16 is a value not exceeding τs−φ, which is the difference between the dimension τs and the diameter φ.

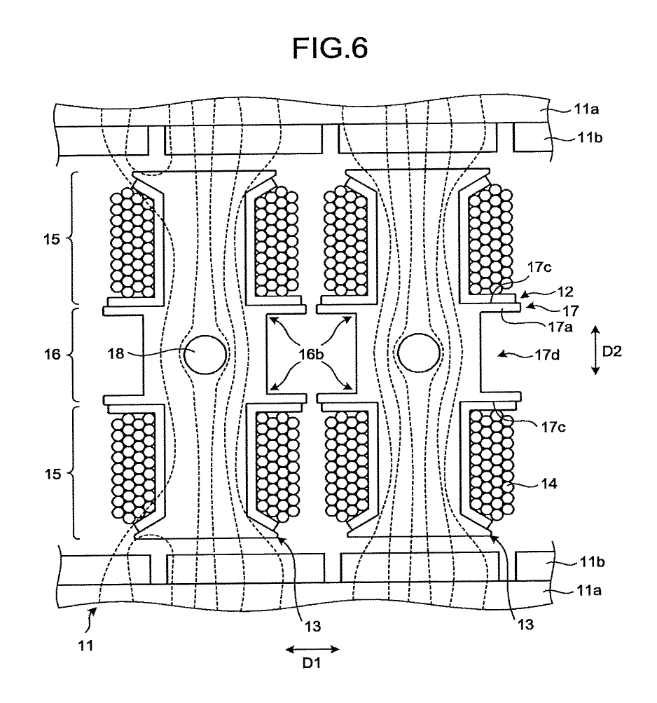

FIG. 6 is a view illustrating an example of lines of magnetic flux formed through the armature cores 13 according to the first embodiment. In FIG. 6, part of the field element 11 and the armature 12 is enlarged for illustration. As illustrated in FIG. 6, in each armature core 13, magnetic flux flows from one tooth 15 through the teeth connecting portion 16 to the other tooth 15. At this time, the magnetic flux detours outward in the first direction D1 to avoid the mounting hole 18. Since the magnetic circuit width of the teeth connecting portion 16 is made larger than or equal to the magnetic circuit width of the teeth 15 as described above, the magnetic flux detouring around the mounting hole 18 is within the teeth connecting portion 16, and does not flow to the support 17 side. Thus, in the first direction D1, portions outside of the end faces 16a of the teeth connecting portion 16, that is, portions at which the support 17 is provided are portions unnecessary in the magnetic circuit. The provision of the spaces 17b in the portions unnecessary in the magnetic circuit does not cause magnetic saturation, and does not affect the flow of magnetic flux.

As above, according to the present embodiment, the spaces 17b are provided in portions of the armature core 13 unnecessary in the magnetic circuit. This can reduce the weight of the armature core 13 without affecting magnetic flux flowing through the armature core 13. Further, by the provision of the projections 17a at the support 17, the windings 14 can be supported. Thus, the falling of the windings 14 can be prevented, and the windings 14 can be wound more in the slots 15a than ever before. An increased number of turns of the windings 14 allows a larger current to be passed, and thus can increase the thrust. Thus, the reduced weight and the increased thrust of the armature cores 13 can increase the acceleration of the armature 12. This can provide the armature core 13 capable of increasing the speed of travel of the armature 12.

Further, according to the present embodiment, the plurality of armature cores 13 are mounted, and thus the armature 12 that enables speeding-up can be provided. Further, according to the present embodiment, the linear motor 10 that enables the speeding-up of travel of carrier can be provided since the armature 12 is mounted thereon.

### Second Embodiment

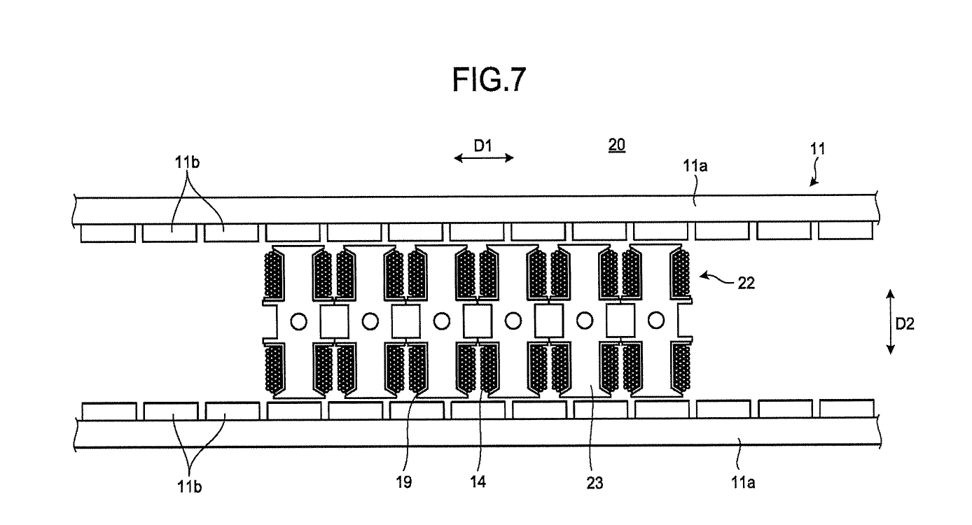

FIG. 7 is a plane cross-sectional view illustrating a linear motor 20 according to a second embodiment. In the second embodiment, the same components as the components of the linear motor 10 according to the first embodiment are given the same reference characters, and their descriptions are omitted or simplified.

As shown in FIG. 7, the linear motor 20 includes a field element 11 as a stator, and an armature 22 as a moving element. The armature 22 is disposed between permanent magnets 11b in two rows of the field element 11. The armature 22 has a plurality of armature cores 23 arranged in a line in a first direction D1, and windings 14 held on the armature cores 23.

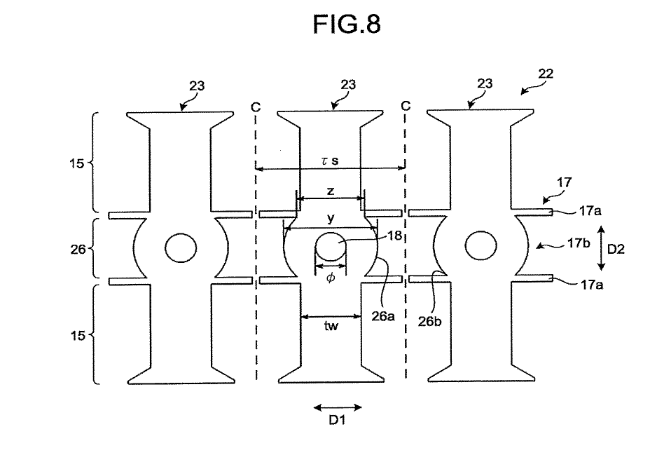

FIG. 8 is a view illustrating the configuration and dimensions of parts of the armature core 23 according to the second embodiment. As illustrated in FIG. 8, the armature core 23 has two teeth 15 and a teeth connecting portion 26 that connects the two teeth 15 together. The armature core 23 is formed in a shape symmetric in a second direction D2.

The teeth connecting portion 26 has a circular mounting hole 18. The teeth connecting portion 26 has protruding portions 26a protruding to both sides in the first direction D1. The surface of each protruding portion 26a is a part of a cylindrical surface. The surface of each protruding portion 26a is curved outward in the first direction D1. Each protruding portion 26a becomes larger in the amount of protrusion in the first direction D1 from end portions 26b to a central portion of the teeth connecting portion 26 in the second direction D2.

A support 17 protrudes from the teeth connecting portion 26 in the first direction D1. The support 17 has projections 17a and spaces 17b. The projections 17a protrude in the first direction D1 from the end portions 26b of the teeth connecting portion 26 on both sides in the second direction D2. The spaces 17b are formed in portions each surrounded by the two projections 17a aligned in the second direction D2 and the surface of the protruding portion 26a of the teeth connecting portion 26. By the formation of the spaces 17b in the support 17, the armature core 23 is reduced in weight.

As illustrated in FIG. 8, the dimension in the first direction D1 of the teeth 15 is tw, the dimension in the first direction D1 of the teeth connecting portion 26 at the central portion in the second direction D2 is y, the dimension in the first direction D1 of the teeth connecting portion 26 at the end portions 26b is z, the diameter of the mounting hole 18 is φ, and the pitch of the armature core 23 in the first direction D1 is τs. Then, the parts of the armature core 23 satisfy τs−φ>z≧tw, and τs−φ>y−p≧tw, and y>z. The dimension z in the first direction D1 of the teeth connecting portion 26 at the end portions 26b is equal to a magnetic circuit width at the end portions 26b of the teeth connecting portion 26. Here, when the magnetic circuit width z of the end portions 26b of the teeth connecting portion 26 is smaller than a magnetic circuit width tw of the teeth 25, magnetic saturation occurs at the end portions 26b of the teeth connecting portion 26. By contrast, the parts of the armature core 23 satisfy the above expression z≧tw. Thus, the magnetic circuit width z of the end portions 26b of the teeth connecting portion 26 is equal to the magnetic circuit width tw of the teeth 25, or larger than the magnetic circuit width tw of the teeth 25. A magnetic circuit is formed around the mounting hole 18 in the teeth connecting portion 26, so that no magnetic circuit is formed in the mounting hole 18. Thus, y−φ, which is the difference between the dimension y and the diameter φ, is equal to a magnetic circuit width at the central portion in the second direction D2 of the teeth connecting portion 26. Here, when the magnetic circuit width y−φ of the central portion in the second direction D2 of the teeth connecting portion 26 is smaller than the magnetic circuit width tw of the teeth 25, magnetic saturation occurs at the central portion in the second direction D2 of the teeth connecting portion 26. By contrast, the parts of the armature core 23 satisfy the above expression y−φ≧tw. Thus, the magnetic circuit width y−φ of the central portion in the second direction D2 of the teeth connecting portion 26 is equal to the magnetic circuit width tw of the teeth 25, or larger than the magnetic circuit width tw of the teeth 25. This avoids magnetic saturation at the end portions 26b and the central portion in the second direction D2 of the teeth connecting portion 26, and thus can prevent a reduction in thrust.

In the teeth connecting portion 26, magnetic flux detours around the mounting hole 18, and thus flows, curving outward in the first direction D1 with respect to the mounting hole 18. Since the end portions 26b of the teeth connecting portion 26 are disposed apart from the mounting hole 18 in the second direction D2, at the end portions 26b, magnetic flux flows without detouring in the first direction D1. Thus, in the teeth connecting portion 26, magnetic flux does not flow outward in the first direction D1 at the end portions 26b, and from the end portions 26b to the central portion in the second direction D2, magnetic flux flows, curving outward in the first direction D1. In the armature core 23, the amount of protrusion in the first direction D1 of the protruding portions 26a becomes larger from both ends to the center in the second direction D2, and the shape of the protruding portions 26a is formed along the flow of magnetic flux. In the teeth connecting portion 26, unnecessary portions in the magnetic circuit are removed more than in the first embodiment.

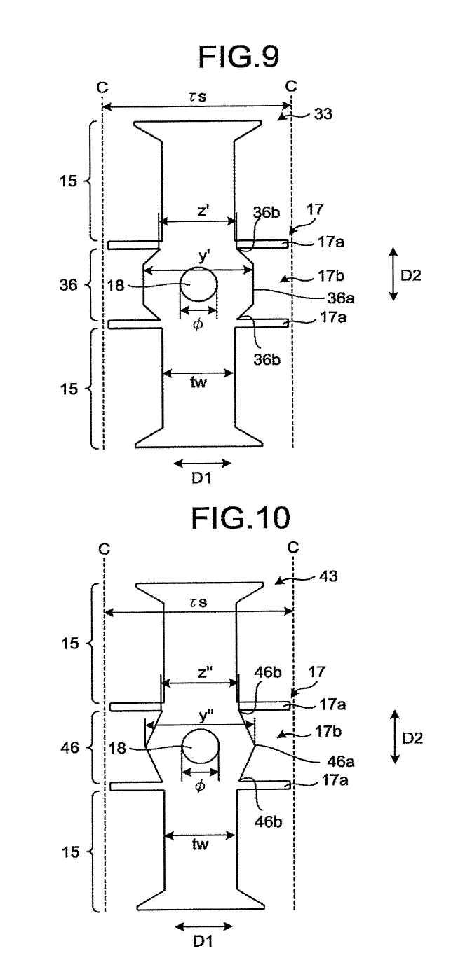

FIG. 9 is a plan view illustrating another armature core 33 according to the second embodiment. The same components as the components of the armature core 23 are given the same reference characters, and their descriptions are omitted or simplified. As illustrated in

FIG. 9, the armature core 33 has two teeth 15 and a teeth connecting portion 36 that connects the two teeth 15 together. The armature core 33 is formed in a shape symmetric in the second direction D2.

The teeth connecting portion 36 has a mounting hole 18. The teeth connecting portion 36 has protruding portions 36a protruding to both sides in the first direction D1. The protruding portions 36a are formed in a trapezoidal shape. Thus, the surface of each protruding portion 36a is formed by a combination of flat surfaces. Therefore, they can be manufactured more easily than when cylindrical surfaces are formed. Each protruding portion 36a becomes larger in the amount of protrusion in the first direction D1 from end portions 36b to a central portion of the teeth connecting portion 36 in the second direction D2. The both end portions 36b in the second direction D2 of the teeth connecting portion 36 are formed in a shape cut triangularly inwardly in the first direction D1.

A support 17 protrudes from the teeth connecting portion 36 in the first direction D1. The support 17 has projections 17a and spaces 17b. The spaces 17b are formed in portions each surrounded by the two projections 17a aligned in the second direction D2 and the surface of the protruding portion 36a of the teeth connecting portion 36. By the formation of the spaces 17b in the support 17, the armature core 33 is reduced in weight.

As illustrated in FIG. 9, the dimension in the first direction D1 of the teeth 15 is tw, the dimension in the first direction D1 of the teeth connecting portion 36 at the central portion in the second direction D2 is y′, the dimension in the first direction D1 of the teeth connecting portion 36 at the end portions 36b is z′, the diameter of the mounting hole 18 is φ, and the pitch of the armature core 33 in the first direction D1 is τs. Then, the parts of the armature core 33 satisfy τs−φ>z′≧tw, and τs−φ>y′−φ≧tw, and y′>z′. The dimension z′ in the first direction D1 of the teeth connecting portion 36 at the end portions 36b is equal to a magnetic circuit width at the end portions 36b of the teeth connecting portion 36. Here, when the magnetic circuit width z′ of the end portions 36b of the teeth connecting portion 36 is smaller than a magnetic circuit width tw of the teeth 35, magnetic saturation occurs at the end portions 36b of the teeth connecting portion 36. By contrast, the parts of the armature core 33 satisfy the above expression z′≧tw. Thus, the magnetic circuit width z′ of the end portions 36b of the teeth connecting portion 36 is equal to the magnetic circuit width tw of the teeth 35, or larger than the magnetic circuit width tw of the teeth 35. A magnetic circuit is formed around the mounting hole 18 in the teeth connecting portion 36, so that no magnetic circuit is formed in the mounting hole 18. Thus, y′−φ, which is the difference between the dimension y′ and the diameter φ, is equal to a magnetic circuit width at the central portion in the second direction D2 of the teeth connecting portion 36. Here, when the magnetic circuit width y′−φ of the central portion in the second direction D2 of the teeth connecting portion 36 is smaller than the magnetic circuit width tw of the teeth 35, magnetic saturation occurs at the central portion in the second direction D2 of the teeth connecting portion 36. By contrast, the parts of the armature core 33 satisfy the above expression y′−φ≧tw. Thus, the magnetic circuit width y′−φ of the central portion in the second direction D2 of the teeth connecting portion 36 is equal to the magnetic circuit width tw of the teeth 35, or larger than the magnetic circuit width tw of the teeth 35. This avoids magnetic saturation at the end portions 36b and the central portion in the second direction D2 of the teeth connecting portion 36, and thus can prevent a reduction in thrust.

Since the end portions 36b of the teeth connecting portion 36 are disposed apart from the mounting hole 18 in the second direction D2, magnetic flux at the end portions 36b flows without detouring in the first direction D1. Thus, in the teeth connecting portion 36, magnetic flux does not flow outward in the first direction D1 at the end portions 36b, and from the end portions 36b to the central portion in the second direction D2, magnetic flux flows, curving outward in the first direction D1. In the armature core 33, the amount of protrusion in the first direction D1 of the protruding portions 36a becomes larger from both ends to the center in the second direction D2, and the shape of the protruding portions 36a is formed along the flow of magnetic flux. In the teeth connecting portion 36, unnecessary portions in the magnetic circuit are removed more than in the first embodiment.

FIG. 10 is a plan view illustrating another armature core 43 according to the second embodiment. The same components as the components of the armature core 23 are given the same reference characters, and their descriptions are omitted or simplified. As illustrated in FIG. 10, the armature core 43 has two teeth 15 and a teeth connecting portion 46 that connects the two teeth 15 together. The teeth connecting portion 46 is formed with protruding portions 46a protruding to both sides in the first direction D1.

The protruding portions 46a are formed in a triangular shape. Thus, the surface of each protruding portion 46a is formed by a combination of flat surfaces. Therefore, they can be manufactured more easily than when cylindrical surfaces are formed. Further, the protruding portions 46a have fewer corners than trapezoidal protruding portions. Therefore, they can be manufactured more easily than when trapezoidal protruding portions are formed. Further, the protruding portions 46a have larger removed portions than trapezoidal protruding portions, thus enabling a further reduction in weight.

Each protruding portion 46a becomes larger in the amount of protrusion in the first direction D1 from end portions 46b to a central portion of the teeth connecting portion 46 in the second direction D2. Magnetic flux does not flow outward in the first direction D1 from the end portions 46b. Thus, the armature core 43 is configured such that portions through which magnetic flux does not flow are removed. The teeth connecting portion 46 is formed with the both end portions 46b in the second direction D2 cut inwardly in the first direction D1 into a triangular shape.

A support 17 protrudes from the teeth connecting portion 46 in the first direction D1. The support 17 has projections 17a and spaces 17b. The spaces 17b are formed in portions each surrounded by the two projections 17a aligned in the second direction D2 and the surface of the protruding portion 46a of the teeth connecting portion 46. By the formation of the spaces 17b in the support 17, the armature core 43 is reduced in weight.

As illustrated in FIG. 10, the dimension in the first direction D1 of the teeth 15 is tw, the dimension in the first direction D1 of the teeth connecting portion 46 at a central portion in the second direction D2 is y″, the dimension in the first direction D1 of the teeth connecting portion 46 at the end portions 46b is z″, the diameter of the mounting hole 18 is p, and the pitch of the armature core 43 in the first direction D1 is τs. Then, the parts of the armature core 43 satisfy τs−φ>z″≧tw, and τs−φ>y″−φ≧tw, and y″>z″. The dimension z″ in the first direction D1 of the teeth connecting portion 46 at the end portions 46b is equal to a magnetic circuit width at the end portions 46b of the teeth connecting portion 46. Here, when the magnetic circuit width z″ of the end portions 46b of the teeth connecting portion 46 is smaller than a magnetic circuit width tw of the teeth 45, magnetic saturation occurs at the end portions 46b of the teeth connecting portion 46. By contrast, the parts of the armature core 43 satisfy the above expression z″≧tw. Thus, the magnetic circuit width z″ of the end portions 46b of the teeth connecting portion 46 is equal to the magnetic circuit width tw of the teeth 45, or larger than the magnetic circuit width tw of the teeth 45. A magnetic circuit is formed around the mounting hole 18 in the teeth connecting portion 46, so that no magnetic circuit is formed in the mounting hole 18. Thus, y″−φ, which is the difference between the dimension y″ and the diameter φ, is equal to a magnetic circuit width of the central portion in the second direction D2 of the teeth connecting portion 46. Here, when the magnetic circuit width y″−φ of the central portion in the second direction D2 of the teeth connecting portion 46 is smaller than the magnetic circuit width tw of the teeth 45, magnetic saturation occurs at the central portion in the second direction D2 of the teeth connecting portion 46. By contrast, the parts of the armature core 43 satisfy the above expression y″−φ≧tw. Thus, the magnetic circuit width y″−φ of the central portion in the second direction D2 of the teeth connecting portion 46 is equal to the magnetic circuit width tw of the teeth 45, or larger than the magnetic circuit width tw of the teeth 45. This avoids magnetic saturation at the end portions 46b and the central portion in the second direction D2 of the teeth connecting portion 46, and thus can prevent a reduction in thrust.

Since the end portions 46b of the teeth connecting portion 46 are disposed apart from the mounting hole 18 in the second direction D2, at the end portions 46b, magnetic flux flows without detouring in the first direction D1. Thus, in the teeth connecting portion 46, magnetic flux does not flow outward in the first direction D1 at the end portions 46b, and from the end portions 46b to the central portion in the second direction D2, magnetic flux flows, curving outward in the first direction D1. In the armature core 43, the amount of protrusion in the first direction D1 of the protruding portions 46a becomes larger from both ends to the center in the second direction D2, and the shape of the protruding portions 46a is formed along the flow of magnetic flux. In the teeth connecting portion 46, unnecessary portions in the magnetic circuit are removed more than in the first embodiment.

As above, the present embodiment is configured with unnecessary portions in the magnetic circuit removed more than in the first embodiment, and thus can reduce the weight of the armature cores 23, 33, and 43 without affecting lines of magnetic flux flowing through the magnetic circuit. Further, by supporting the windings 14 by the projections 17a, the windings 14 can be wound more in the slots 15a than ever before, and thus can increase the thrust. Thus, the reduced weight and the increased thrust of the armature cores 23, 33, and 43 can increase the acceleration of the armature. This can provide the armature cores 23, 33, and 43 capable of increasing the speed of travel of the armature.

### Third Embodiment

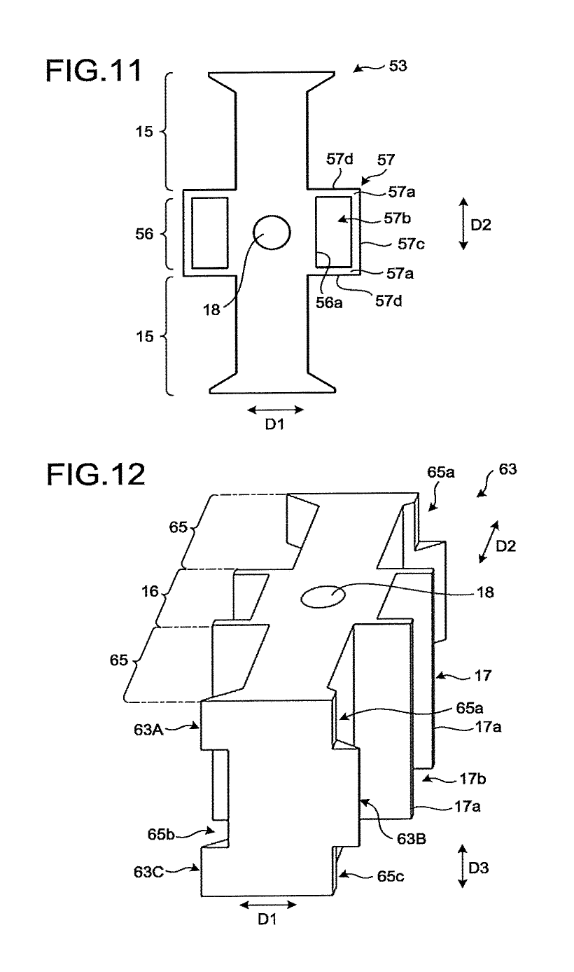

FIG. 11 is a plan view illustrating an armature core 53 according to a third embodiment. In the third embodiment, the same components as the components of the armature core 13 according to the first embodiment are given the same reference characters, and their descriptions are omitted or simplified.

As illustrated in FIG. 11, the armature core 53 has two teeth 15 and a teeth connecting portion 56 that connects the two teeth 15 together. A support 57 is provided at the teeth connecting portion 56. The support 57 protrudes from the teeth connecting portion 56 in a first direction D1.

The support 57 has projections 57a, spaces 57b, and wall portions 57c. The projections 57a protrude in the first direction D1 from both end portions 56b in a second direction D2 of the teeth connecting portion 56. The projections 57a can support windings 14 on faces 57d on the teeth 15 sides.

The wall portions 57c are disposed at both end portions in the first direction D1 of the support 57. The wall portions 57c each connect distal ends of the two projections 57a aligned in the second direction D2 together. The distal ends of the projections 57a are supported by the wall portions 57c in the second direction D2.

The spaces 57b are formed in portions each enclosed by the two projections 57a, an end face 56a of the teeth connecting portion 56, and the wall portion 57c. By the formation of the spaces 57b in the support 57, the armature core 53 is reduced in weight.

According to the present embodiment, the reduced weight and the increased thrust of the armature core 53 can increase the acceleration of an armature when the armature core 53 is mounted on the armature. This can provide the armature core 53 capable of increasing the speed of travel of the armature. Further, the provision of the wall portions 57c results in a configuration in which the distal ends of the projections 57a are supported in the second direction D2. Thus, the windings 14 can be supported more reliably.

### Fourth Embodiment

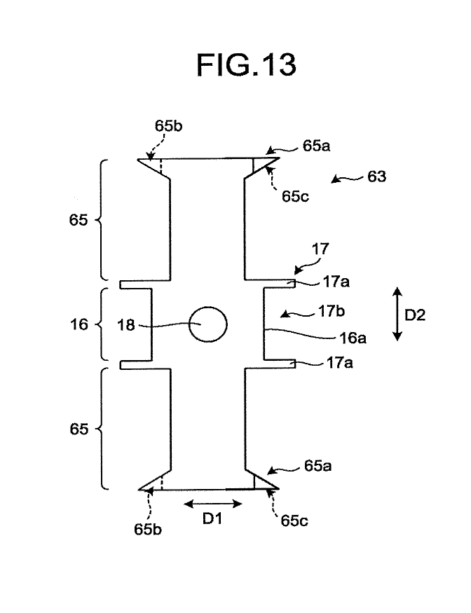

FIG. 12 is a perspective view illustrating an armature core 63 according to a fourth embodiment. FIG. 13 is a plan view illustrating the armature core 63 according to the fourth embodiment. In the fourth embodiment, the same components as the components of the armature core 13 according to the first embodiment are given the same reference characters, and their descriptions are omitted or simplified.

As illustrated in FIGS. 12 and 13, the armature core 63 has two teeth 65 and a teeth connecting portion 16 that connects the two teeth 65 together.

The teeth 65 are disposed at both ends of the armature core 63 in a second direction D2. A slot is formed in each tooth 65. A bobbin 19 and a winding 14 are fitted in the slot. The armature core 63 has a first block 63A, a second block 635, and a third block 63C, three core blocks, in a third direction D3 perpendicular to the second direction D2 and a first direction D1.

In the first block 63A, notches 65a are formed in distal end portions in the second direction D2 of the teeth 65. In the second block 635, notches 65b are formed in distal end portions in the second direction D2 of the teeth 65. In the third block 63C, notches 65c are formed in distal end portions in the second direction D2 of the teeth 65. Due to the notches 65a, 65b, and 65c, the amount of overhanging of the distal end portions of the teeth 65 in the first direction D1 differs between one side and the other side in the first direction D1. In the armature core 63 shown in FIG. 12, the amount of overhanging to the left side, which is one side in the first direction D1, at the first block 63A and the third block 63C is larger than the amount of overhanging to the right side which is the other side in the first direction D1. At the second block 63B, the amount of overhanging to the left side, which is one side in the first direction D1, is smaller than the amount of overhanging to the right side, which is the other side in the first direction D1. This forms a stage skew structure between the first block 63A and the second block 63B, and between the second block 635 and the third block 63C. The stage skew structure is provided to reduce the influence of cogging thrust and thrust ripples, and reduce the pulsation of thrust depending on the location of the armature. The dimensional ratio in the third direction D3 between the first block 63A, the second block 635, and the third block 63C may be 1:2:1, but is not limited to this.

A support 17 is provided at the teeth connecting portion 16. A support 17 protrudes from the teeth connecting portion 26 in the first direction D1. The support 17 has projections 17a and spaces 17b. The projections 17a protrude in the first direction D1 from end portions 16b of the teeth connecting portion 16 on both sides in the second direction D2. The spaces 17b are formed in portions each surrounded by the two projections 17a aligned in the second direction D2 and the end face 16a of the teeth connecting portion 16. By the formation of the spaces 17b in the support 17, the armature core 13 is reduced in weight.

According to the present embodiment, the reduced weight and the increased thrust of the armature core 63 can increase the acceleration of an armature when the armature core 63 is mounted on the armature. This can provide the armature core 63 capable of increasing the speed of travel of the armature. Since the armature core 63 is formed with the three core blocks in the thirty-three direction D3, and is provided with the notches 65a, 65b, and 65c, a linear motor with smaller pulsation of thrust depending on the location of an armature can be obtained.

In the present embodiment, the armature core 63 is configured with the three core blocks formed in the third direction D3, and with the first block 63A and the third block 63C overhanging to one side in the first direction D1 and the second block 63B to the other side in the first direction D1, but is not limited to this. The armature core 63 may be configured with the three core blocks formed in the third direction D3, and with the second block overhanging more than the first block to one side in the first direction D1, and with the third block overhanging further than the second block to the one side in the first direction D1. Alternatively, the armature core 63 may be configured with two core blocks formed in the third direction D3, with a first block overhanging to one side in the first direction D1 and a second block to the other side in the first direction D1.

### Fifth Embodiment

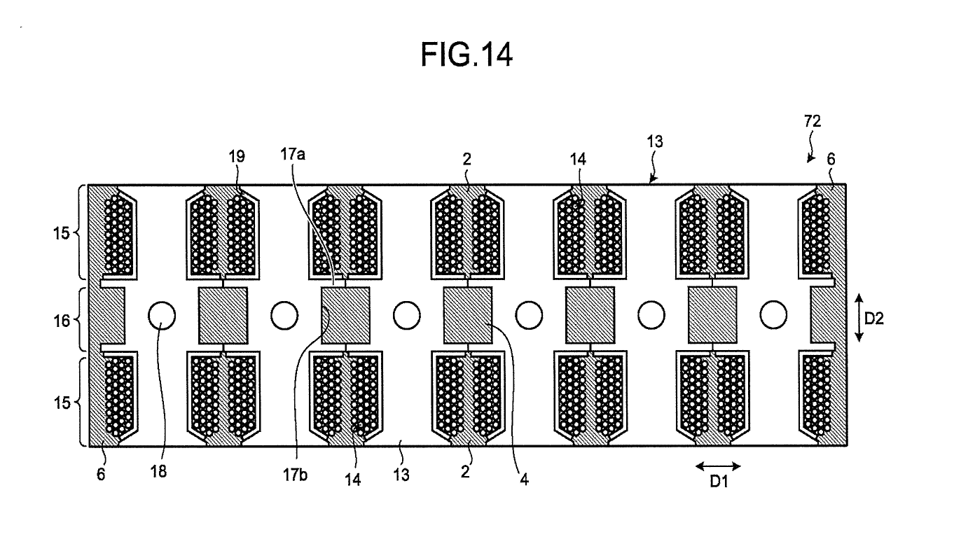

FIG. 14 is a plane cross-sectional view illustrating an armature 72 according to a fifth embodiment. In the fifth embodiment, the same components as the components of the armature 12 according to the first embodiment are given the same reference characters, and their descriptions are omitted or simplified.

As illustrated in FIG. 14, the armature 72 has a plurality of armature cores 13 arranged in a line in a first direction D1, and windings 14 held on the armature cores 13. Between adjacent teeth 15, a gap is formed between the windings 14 wound on the teeth 15. Between adjacent teeth connecting portions 16, spaces 17b face each other, forming a gap.

The armature 72 has resin portions 2, 4, and 6 provided between the adjacent armature cores 13. The resin portions 2, 4, and 6 are formed using a material having electrical insulation properties, and electrically insulate the armature cores 13 from each other. For the resin portions 2, 4, and 6, an epoxy resin or a polyester resin is used. The resin portions 2 are disposed between the teeth 15. With the resin portions 2, the teeth 15 and the windings 14 are molded. The resin portions 4 are disposed between the teeth connecting portions 16. With each resin portion 4, the gap formed by two opposing spaces 17b is filled entirely. The resin portions 6 cover the windings 14 on the armature cores 13 disposed at both ends in the first direction D1. With the resin portions 6, the spaces 17b of the armature cores 13 disposed at both ends in the first direction D1 are filled.

This disposition of the resin portions 2, 4, and 6 in the gaps between the adjacent armature cores 13 can improve the thermal conductivity of the armature 72. Thus, heat generated by the windings 14 can be efficiently released, preventing an increase in the temperature of the windings 14. A rated thrust that enables the continuous operation of a linear motor is determined by the heat resistance temperature upper limit of the windings 14. By reducing an increase in the temperature of the windings 14, a reduction in rated thrust can be prevented. The resin portions 2, 4, and 6 may contain alumina powder to enhance the thermal conductivity.

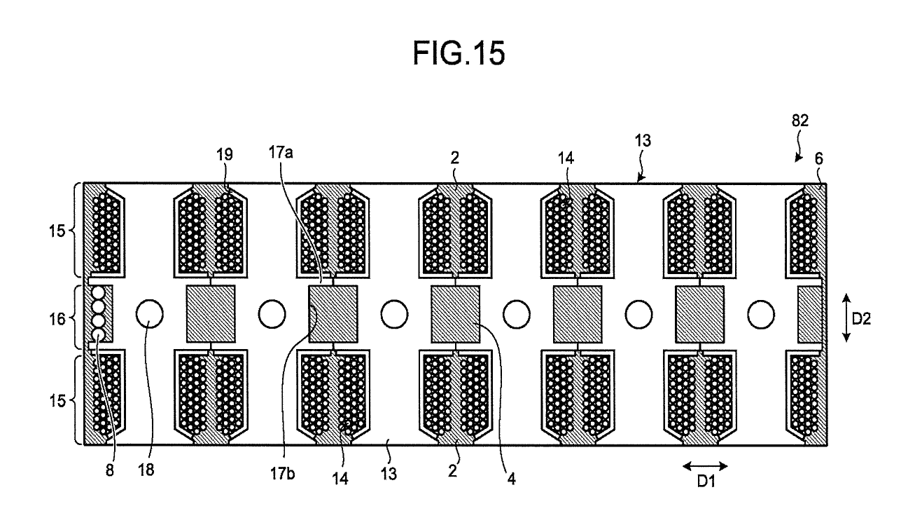

FIG. 15 is a plane cross-sectional view illustrating another armature 82 according to the fifth embodiment. As illustrated in FIG. 15, power wiring 8 of a linear motor is disposed in the armature 82. The power wiring 8 is disposed in a space 17b of an armature core 13 provided at an end portion of the armature 82 in the first direction D1. The power wiring 8 is disposed inside a resin portion 6 with which the space 17b is filled. The disposition of the power wiring 8 in the space 17b can make the size of the armature 82 smaller by the size of the power wiring 8 than when the power wiring 8 is disposed outside in the traveling direction of the armature 82. Further, by molding the power wiring 8 with the resin portion 6, the amount of use of mold resin can be reduced by the volume of the power wiring 8, so that the armature 82 can be reduced in weight. Thus, the acceleration of the armature 82 can be increased.

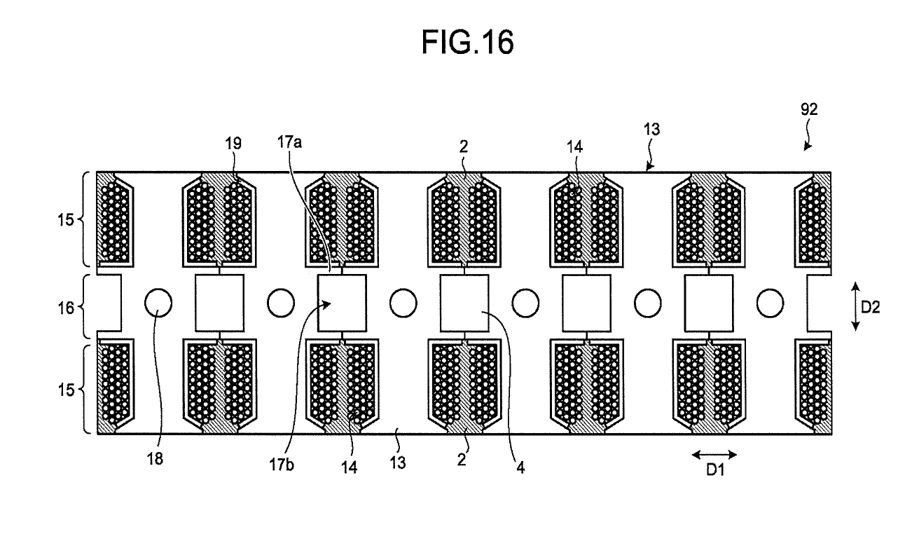

FIG. 16 is a plane cross-sectional view illustrating another armature 92 according to the fifth embodiment. As illustrated in FIG. 16, in the armature 92, resin portions 2 with which windings 14 are molded together are disposed between teeth 15. Spaces 17b are formed in a hollow shape without the disposition of resin portions. Thus, the heat of the windings 14 can be efficiently released by the resin portions 2 with which the windings 14 are molded. Further, by the configuration in which no resin portions are provided in the spaces 17b, the weight can be reduced, compared to the armature 72 illustrated in FIG. 14. Thus, the armature 92 can be increased in acceleration.

The configurations shown in the above embodiments illustrate an example of the subject matter of the present invention, and can be combined with another known art, and can be partly omitted or changed without departing from the scope of the present invention.

### REFERENCE SIGNS LIST

2, 4, and 6 resin portion, 8 power wiring, 10 and 20 linear motor, 11 field element, 12 and 22 armature, 13, 23, 33, 43, 53, and 63 armature core, 14 winding, 15 and 65 tooth, 16, 26, 36, 46, and 56 teeth connecting portion, 17 and 57 support, 17a and 57a projection, 17h and 57b space, 18 mounting hole, 26a, 36a, and 46a protruding portion, 26b, 36b, and 46b end portion, 57c wall portion, 72, 82, and 92 armature, D1 first direction, D2 second direction.

1. An armature core comprising:
two teeth on which windings are wound; and
a teeth connecting portion disposed between the two teeth, connecting the teeth together, and having a mounting hole formed therein, the two teeth and the teeth connecting portion being arranged in a line,
the teeth connecting portion having a support to support the windings,
the support having projections protruding from both end portions of the teeth connecting portion in an arrangement direction which is a direction in which the two teeth and the teeth connecting portion are aligned, to both sides in a width direction which is a direction orthogonal to the arrangement direction, and spaces formed between the projections in the arrangement direction,
wherein the projections are formed in a plate shape.

2. (canceled)

3. The armature core according to claim 1,
wherein the support has wall portions connecting distal ends of the projections together.

4. The armature core according to claim 1 satisfying
τs−φ>x−φ≧tw
where tw is a dimension in the width direction of the teeth, x is a dimension in the width direction of the teeth connecting portion at a portion defined between the spaces on both sides thereof, φ is a diameter of the mounting hole, and τs is a pitch in the width direction when a plurality of the armature cores is provided in an armature of a linear motor.

5. An armature core comprising:
two teeth on which windings are wound; and
a teeth connecting portion disposed between the two teeth, connecting the teeth together, and having a mounting hole formed therein, the two teeth and the teeth connecting portion being arranged in a line,
the teeth connecting portion having a support to support the windings,
the support having projections protruding from both end portions of the teeth connecting portion in an arrangement direction which is a direction in which the two teeth and the teeth connecting portion are aligned, to both sides in a width direction which is a direction orthogonal to the arrangement direction, and spaces formed between the projections in the arrangement direction,
wherein
the teeth connecting portion has protruding portions protruding in the width direction and disposed between the projections in the arrangement direction, and
the protruding portions become larger in protruding amount from the end portions to a central portion in the arrangement direction.

6. The armature core according to claim 5 satisfying
τs−φ>z≧tw, and τs−φ>y−φ≧tw, and y>z
where tw is a dimension in the width direction of the teeth, y is a dimension in the width direction of the teeth connecting portion at the central portion in the arrangement direction between the spaces on both sides thereof, z is a dimension in the width direction of the teeth connecting portion at the end portions in the arrangement direction, φ is a diameter of the mounting hole, and is τs a pitch in the width direction when a plurality of the armature cores is provided in an armature of a linear motor.

7. An armature comprising the armature core according to claim 1.

8. The armature according to claim 7, wherein
a plurality of the armature cores is arranged in a line in the width direction, and
the armature comprises resin portions disposed between the armature cores adjacent to each other.

9. A linear motor comprising the armature according to claim 7.

10. An armature comprising the armature core according to claim 5.

11. The armature according to claim 10, wherein
a plurality of the armature cores is arranged in a line in the width direction, and
the armature comprises resin portions disposed between the armature cores adjacent to each other.

12. A linear motor comprising the armature according to claim 10.
